(19) United States
(12) Patent Application Publication
(10) Pub. No.: US 2009/0304194 A1
(43) Pub. Date: Dec. 10, 2009

(54) Identification Method and Apparatus in an Audio System

(75) Inventors: William Eggleston, Wayland, MA (US); Pekka Moilanen, Iisalmi (FI); Aki Mäkivirta, Lapinlahti (FI); Jussi Tikkanen, Iisalmi (FI)

Correspondence Address: Muncy, Geissler, Olds & Lowe, PLLC, P.O. BOX 1364, FAIRFAX, VA, 22038-1364, US

(73) Assignee: GENELEC OY, IISALMI (FI)

(21) Appl. No.: 12/294,903

(22) PCT Filed: Mar. 23, 2007
(86) PCT No.: PCT/FI2007/050157

§ 371 Date: Jun. 18, 2009

Related U.S. Application Data
(60) Provisional application No. 60/786,373, filed on Mar. 28, 2006.

(30) Foreign Application Priority Data
Oct. 13, 2006 (FI) 20060910

(51) Int. Cl. H04R 29/00

(52) U.S. Cl. 381/59

(57) ABSTRACT

An identification method and apparatus in a sound-reproduction system, in which an electrical calibration signal is created, an audio signal is created in the loudspeaker from the calibration signal, the response of the audio signal is measured and analysed, and the system is adjusted on the basis of the measurement results. A light signal is created in the loudspeaker with the aid of a centralized control system, in order to indicate visually the loudspeaker that is the subject of the calibration.

### BACKGROUND OF THE INVENTION

1. Field of the Invention

The present invention relates to an identification method in a sound-reproduction system, in which an electrical calibration signal is created, an audio signal is created in the loudspeaker from the calibration signal, the response of the audio signal is measured and analysed, and the system is adjusted on the basis of the measurement results.

The invention also relates to an identification apparatus.

2. Brief Discussion of the Related Art

According to the prior art, multi-loudspeaker systems are known, in which individual loudspeaker elements are selected as the subject of measurement and calibration for calibration and measurement purposes. It is of course possible to identify an individual loudspeaker with the aid of cabling, but as there can be as many as tens of loudspeakers, it is difficult to rapidly identify the individual loudspeaker that is the subject of measurement.

The invention is intended to eliminate the defects of the state of the art disclosed above and for this purpose create an entirely new type of method and apparatus for identifying a loudspeaker.

### SUMMARY OF THE INVENTION

The invention is based on using the control system to form a visual possibility to facilitate identifying a loudspeaker being tested, from a group of other loudspeakers. More specifically, the method according to the invention is characterized by—a light signal created in the loudspeaker with the aid of a centralized control system, in order to indicate visually the loudspeaker that is the subject of the calibration, and the state of the loudspeaker is expressed with the aid of the colour or blinking of the light signal.

The apparatus according to the invention is, in turn, characterized by means in the loudspeaker for creating a light signal with the aid of a centralized control system, in order to indicate visually the loudspeaker that is the subject of the calibration, and means for identifying the state of the loudspeaker, with the aid of the colour or blinking of a light signal.

Considerable advantages are gained with the aid of the invention.

With the aid of the method according to the invention the loudspeaker being tested can be easily identified and, with the aid of the identification, the success of the test event can be monitored. Identification will also permit the easy indication of fault situations.

The invention is particularly advantageous in connection with the calibration methods disclosed in the application.

Light indication can be used to depict various operating states with the aid of lights, thus increasing the information for the user.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 shows a block diagram of one system suitable for the method according to the invention.

FIG. 2 shows a second system according to the system.

FIG. 3 shows graphically a signal according to the invention, which is stored by the sound card of a computer.

FIG. 4 shows graphically a typically measured signal in a calibration system according to the invention.

FIG. 5 shows graphically a test signal created by a loudspeaker.

The following terminology is used in the invention:
1 loudspeaker
2 loudspeaker control unit
3 acoustic signal
4 microphone
5 preamplifier
6 analog summer
7 sound card
8 computer
9 measurement signal
10 test signal
11 USB connection
12 control-network controller
13 control network
14 IO line
15 signal generator
16 loudspeaker element
17 light source
18 interface device
50 calibration signal

### DETAILED DESCRIPTION OF THE PREFERRED EMBODIMENTS

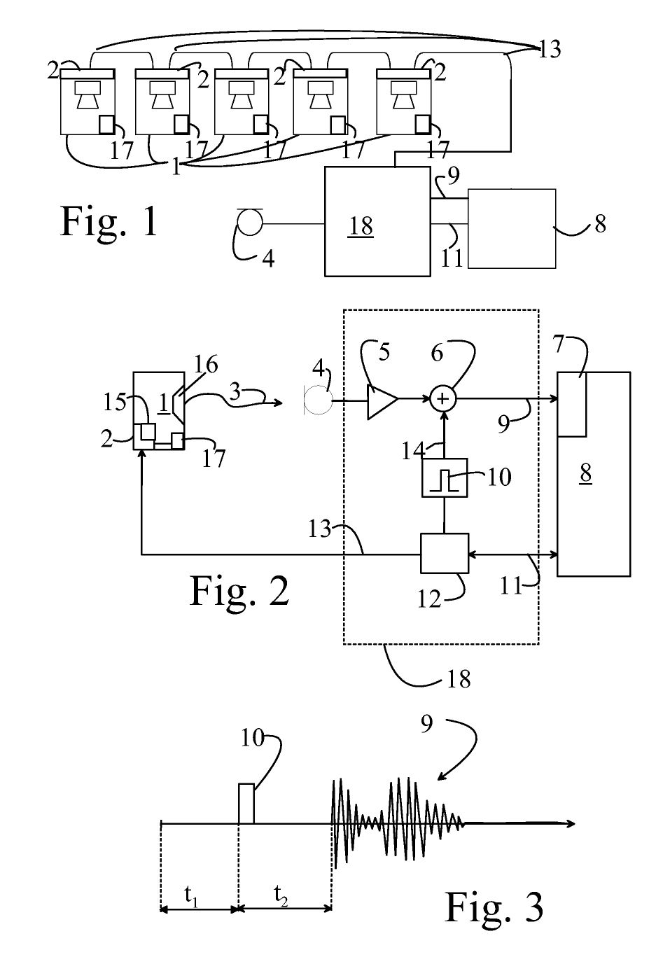

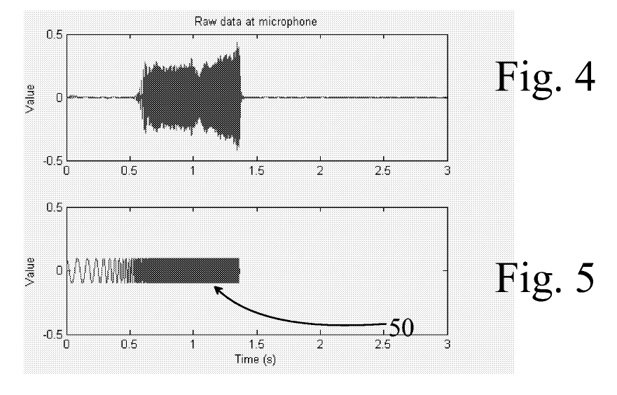

FIG. 1 shows an apparatus totality, in which loudspeakers 1 are connected to a computer 8 through a control network 13, by means of an interface device 18.

In each loudspeaker 1 there is a light source 17, which is controlled by means of a control network 13. The light source 17 can show the status of each loudspeaker 1, which can be shown, for example, using the following codes:

green loudspeaker in normal operation
blinking light loudspeaker selected for operation
yellow light loudspeaker does not belong to a group
red light fault, overloading, cutting

The interface device 18 contains a control-network controller 12 according to FIG. 2, a preamplifier 5 and an analog summer 6, to which an IO line 15 coming from the control-network controller, through which IO line a test signal 10 is transmitted to the summer, is connected.

FIG. 2 includes the same functions as FIG. 1, but for reasons of clarity only a single loudspeaker 1 is shown in it.

FIG. 2 shows an apparatus totality according to the invention, in which the loudspeaker 1 produces an acoustic signal 3. For test purposes, the acoustic signal 3 is formed from an electric calibration signal created by the generator 16 of the control unit 2 of the loudspeaker itself. The control unit 2 typically contains an amplifier, the loudspeaker 1 thus being an active loudspeaker. The test signal is preferably a sinusoidal scanning signal, which is shown graphically, for instance, in FIGS. 3 and 5. The frequency of the calibration signal 50 (FIG. 5) preferably scans over the range of human hearing, in such a way that it starts from the lowest frequencies and is increased towards higher frequencies at a logarithmic speed. The generation of the calibration signal 50 is started from a signal brought through the control bus 13 to the control unit 2 of the loudspeaker 1. The acoustic signal 3 is received using a microphone 4 and is amplified in the preamplifier 5. The signal coming from the preamplifier 5 is combined in the analog summer 6 with a test signal 10, which is typically a rectangular wave. The analog summer 6 is typically a circuit implemented using an operation amplifier. The test signal 10 is obtained from the control unit 12 of the monitoring network. In practice, the test signal can be obtained directly from the IO line 14 of the microprocessor of the monitoring-network control unit.

According to the invention, a light source, such as a LED, incandescent bulb, or similar, which is control by the loudspeaker's control unit 2 through the control bus 13, is arranged in the loudspeaker. The control unit gives the light source control commands particularly in calibration or measurement situations, so that someone in the monitoring room can easily identify the loudspeaker that is the subject of the measurement or calibration and, after the calibration state, listen to the end result while knowing which loudspeaker they are listening to.

The light source can also be used to indicate the state of each loudspeaker. A green light in the light source 17 can depict normal operation, a blinking light the selection of the loudspeaker for measurement or calibration, a yellow light that the loudspeaker does not belong to the group identified by the system, and a red light a fault state, which depicts failure of data traffic or, for example, cutting of the loudspeaker's signal in a measurement and calibration situation.

Thus according to the invention the acoustic measurement signal 3 can be initiated by remote control through the control bus 13. In the same connection, it is also possible to provide a control signal to the light source 17. The microphone 4 receives the acoustic signal 3, with which the test signal 10 is summed. The sound card 7 of the computer 8 receives a sound signal; in which there is first of all the test signal and at a specific time from it (acoustic time of flight) the response 9 of the acoustic measurement signal, according to FIG. 3.

FIG. 3 shows the signal produced by the method described above, using the sound card 7 of a computer. Time t₁ is a randomly variable time caused by the operating system of the computer. Time t₂ from the test signal to the start of the acoustic response 9 is mainly defined on the basis of the acoustic delay (time of travel), and does not contain random variation. The acoustic response 9 is the response of the loudspeaker-room system to a logarithmic sine scan, the frequency of which is increasing.

According to an alternative preferred embodiment of the invention, a generator 15, which produces a precisely previously known calibration signal 50, is built inside the loudspeaker.

The calibration signal produced by the generator 15 is a sine scan, the frequency-scan speed of which increases, in such a way that the logarithm if the momentary frequency is proportional to the time log(f)=k t, in which f is the momentary frequency of the signal, k is a constant defining the speed, and t is the time. The increase in frequency accelerates in time.

Because the test signal is mathematically precisely defined, it can be reproduced precisely in the computer, independently of the test signal produced by the loudspeaker 1.

A measuring signal of this kind all the frequencies and the crest factor (the ratio of the peak level to the RMS level) is highly advantageous, in that the peak level is very close to the RMS level, and thus the signal will produce an extremely good signal-noise ration in measurement.

When the signal 50 begins to move from the low frequencies and its frequency increases, the signal operates advantageously in a room, in which the reverberation time is usually greater at low frequencies than at high frequencies.

The generation of the calibration signal 50 can be commenced using a command given through remote control.

According to a second preferred embodiment of the invention, the magnitude of the calibration signal 50 produced in the loudspeaker can be altered through the control network 13.

The calibration signal 50 is stored. The magnitude of the acoustic response 9 of the calibration signal 50 relative to the calibration signal is measured. If the acoustic response 9 is too small, the level of its calibration signal 50 is increased. If the acoustic response is cut, the level of the calibration signal 50 is decreased.

The measurement is repeated, until the optimal signal-noise ration and acoustic-signal 9 level have been found.

The setting of the level can be performed separately for each loudspeaker. The light source 17 is used to indicate the loudspeaker being used.

Because how much the level has been altered is controlled by the computer 8 and is thus known, this information is taken into account when calculating the results, in which case a reliable measurement result, which is independent of the distance, and which is scaled correctly relative to the level, will be obtained.

According to a third preferred embodiment of the invention, the acoustic impulse response of all of the loudspeakers 1 of the system is measured using the method presented above. A calibration arrangement of this kind is shown in FIG. 1.

The frequency response is calculated from each impulse response.

The distance of the loudspeaker is calculated from each impulse response.

On the basis of the frequency response, equalizer filter settings are designed that will achieve the desired frequency response in the room (even frequency response).

The (relative) sound level produced by the equalized response is calculated.

A delay is set for each loudspeaker, by means of which the measured response of all the loudspeakers will include the same amount of delay (the loudspeakers appear to be equally distant) and each phase is indicated by the light source 17 of the loudspeaker 1, controlled by the control network 13.

A level is set for each loudspeaker, at which the loudspeaker appear to produce the same sound level at the measuring point.

The phase of the sub-woofer(s) is further set in the manner described above.

In this application, the term sound-frequency range refers to the frequency range 10 Hz-20 kHz.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An identification method in a sound-reproduction system, in which an electrical calibration signal is created, an audio signal is created in the loudspeaker from the calibration signal, the response of the audio signal is measured and analysed, and the system is adjusted on the basis of the measurement results, wherein:
a light signal is created in the loudspeaker with the aid of a centralized control system, in order to indicate visually the loudspeaker that is the subject of the calibration, and
the state of the loudspeaker is expressed with the aid of the colour or blinking of the light signal.

2. The method according to claim 1, wherein the calibration signal is created in the loudspeaker itself, in such a way that it is an essentially sinusoidal signal, the frequency of which scans through at least substantially the entire frequency range.

3. The method according to claim 1, wherein whether the loudspeaker is in a normal state, selected, belongs to a group, or is in a fault state, is expressed with the aid of the colour or blinking of the light signal.

4. An identification apparatus in a sound-reproduction system, which comprises means for creating an electrical calibration signal, a loudspeaker for producing an audio signal from the calibration signal, measuring and analysis means for measuring and analysing the response of the audio signal, and adjustment means for adjusting the system on the basis of the measurement results, wherein:
there are means in the loudspeaker for creating a light signal with the aid of a centralized control system, in order to indicate visually the loudspeaker that is the subject of the calibration, and means for identifying the state of the loudspeaker, with the aid of the colour or blinking of a light signal.

5. The apparatus according to claim 4, wherein the loudspeaker itself comprises means for creating a calibration signal, in such a way that it is an essentially sinusoidal signal, the frequency of which scans at least substantially through the entire frequency range.

6. The apparatus according to claim 4, further comprising means for identifying with the aid of light information, whether the loudspeaker is in a normal state, selected, belongs to a group, or is in a fault state.

7. A loudspeaker which comprises a sound-producing element adjustment and control devices for controlling the sound-producing element, and signal and control connections, wherein:
the loudspeaker comprises means for creating a light signal with the aid of a centralized control system, in order to indicate visually the loudspeaker that is the subject of the calibration.

8. The loudspeaker according to claim 7, wherein the loudspeaker is an active loudspeaker.

9. The loudspeaker according to claim 7, wherein the loudspeaker comprises means for implementing an essentially logarithmic frequency scan.

10. The loudspeaker according to claim 7, wherein the loudspeaker comprises means for implementing a frequency scan that starts from the lowest frequencies.
